(19) United States
(12) Patent Application Publication
(10) Pub. No.: US 2010/0312980 A1
(43) Pub. Date: Dec. 9, 2010

(54) MEMORY CARD CHANGER, METHOD FOR READING OR WRITING DATA IN MEMORY CARD CHANGER

(75) Inventors: Seok-Yeon Jeong, Seongnam-si (KR); Seung-Koo Lew, Seongnam-si (KR); Jun-Woo Lee, Gyeonggi-Do (KR)

Correspondence Address: EDWARDS ANGELL PALMER & DODGE LLP, P.O. BOX 55874, BOSTON, MA, 02205, US

(73) Assignees: UNIDUE CO., LTD., Cheongwon-Kun (KR); CHUNGBUK TECHNOPARK, Cheongwon-Kun (KR)

(21) Appl. No.: 12/740,575

(22) PCT Filed: Oct. 7, 2008
(86) PCT No.: PCT/KR2008/005875

§ 371 Date: Apr. 29, 2010

(30) Foreign Application Priority Data
Oct. 30, 2007 (KR) 10-2007-0109795

(51) Int. Cl. G06F 13/40; G06F 12/02

(52) U.S. Cl. 711/166; 710/301; 711/E12.002

(57) ABSTRACT

A memory card changer is disclosed. The memory card changer in accordance with an embodiment of the present invention can include a connector, which interchanges the data with a host device, a built-in memory; a slot, which attaches and detaches the plurality of external memory cards, and a processor, which controls the host device to collectively recognize or individually recognize individual storage capacities of the built-in memory and each of the memory cards inserted in the slot unit. In accordance with the present invention, the memory card changer can collectively manage individual storage capacities of the built-in memory and the plurality of external memory cards inserted in the memory card changer.

### TECHNICAL FIELD

The present invention relates to a memory card changer, more specifically to a memory card changer that manages the storage capacity of a built-in memory and an external memory card collectively or individually.

### BACKGROUND ART

FIG. 1 illustrates the configuration of a conventional memory card reader.

Referring to FIG. 1, a conventional memory card reader 110 includes a USB (universal serial bus) input/output unit 111, which is connected with a host device 100, and a memory card slot 115.

The USB input/output unit 111 uses a USB interface to interchange data between the host device 100 and a memory card inserted in the memory card reader 110.

Inserted in the memory card slot 115 can be various memory cards, such as an SD (secure digital)/MMC (multimedia card) 112, an MS (memory stick) 113 and a CF (compact flash) 114.

In accordance with the related art, the host device 100 recognizes each of the memory cards 112, 113 and 114 inserted in the memory card slot 115 of the memory card reader 110 as an independent mobile storage media.

For instance, if contents data of 1.5 gigabytes from the host device 100 is to be written in a memory card inserted in the memory card reader 110, and if the storage capacities of the SD 112 memory card, the MS 113 and the CF 114 are 1 gigabyte, 0.5 gigabyte and 0.5 gigabyte, respectively, the integrated storage capacity, which combines the individual storage capacities of the SD 112, MS 113 and CF 114 memory cards, is a total of 2 gigabytes, which is greater than the contents data of 1.5 gigabytes.

However, the memory card reader 110 in accordance with the related art only recognizes the memory cards 112, 113 and 114 inserted in the memory card slot 115 as independent mobile drives. For that reason, the contents data can be stored in the memory cards only if the contents data is divided into smaller data through, for example, a compression program, in accordance with the individual storage capacity of each memory card.

### DISCLOSURE

### Technical Problem

The present invention provides a memory card changer that collectively manages individual storage capacities of a built-in memory and external memory cards inserted in the memory card changer.

The present invention also provides a memory card changer that can recognize a plurality of external memory cards having smaller individual storage capacities as a large capacity memory.

Other problems that the present invention solves will become more apparent through the following embodiments described below.

### Technical Solution

To achieve the foregoing objectives and resolve the problems of the related art, an aspect of the present invention provides a memory card changer. The memory card changer in accordance with an embodiment of the present invention can include a connector, which interchanges the data with a host device, a built-in memory; a slot, which attaches and detaches the plurality of external memory cards, and a processor, which controls the host device to collectively recognize or individually recognize individual storage capacities of the built-in memory and each of the memory cards inserted in the slot unit.

Another aspect of the present invention provides a method of storing data in a built-in memory of a memory card changer and an external memory card inserted in the memory card changer. The method in accordance with an embodiment of the present invention includes: (a) storing the data in the built-in memory or the external memory card in accordance with a predetermined order; (b) generating Nth division information and storing the Nth division information in the built-in memory or the external memory card, if data is stored up to a predetermined capacity of an Nth order of the built-in memory or the external memory card; (c) storing data following the data stored in the Nth order of the built-in memory or the external memory card in an N+1th order of the built-in memory or the external memory card; and (d) repeating the steps of (b) and (c) until the data is completely stored.

Another aspect of the present invention provides a method of reading data stored in a built-in memory of a memory card changer and an external memory card inserted in the memory card changer. The method in accordance with an embodiment of the present invention includes: extracting division information from each of the built-in memory and the external memory card; and reading the data stored in the built-in memory and the external memory card by using the extracted division information, in which the division information is stored in the built-in memory and the external memory card when the data is divided and stored in the built-in memory and the external memory card and comprises information on the divided data.

### ADVANTAGEOUS EFFECTS

The memory card changer in accordance with the present invention can collectively manage individual storage capacities of a built-in memory and external memory cards inserted in the memory card changer.

The memory card changer in accordance with the present invention can also recognize a plurality of small capacity external memory cards as a large capacity memory.

### DESCRIPTION OF DRAWINGS

FIG. 1 illustrates the configuration of a conventional memory card reader.

FIG. 2 illustrates the structure of a memory card changer in accordance with an embodiment of the present invention.

FIG. 3 is a flow chart illustrating how data is stored by a memory card changer in accordance with an embodiment of the present invention.

FIG. 4 is a flow chart illustrating how data is read by a memory card changer in accordance with an embodiment of the present invention.

### MODE FOR INVENTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a unit or combinations thereof, and shall not be construed to preclude any presence or possibility of one or more other characteristics, numbers, steps, operations, elements, units or combinations thereof.

Embodiments of the present invention will be described below in detail with reference to the accompanying drawings. For better understanding overall in describing aspects of the present invention, the same reference numerals are used for the same means, regardless of the figure number.

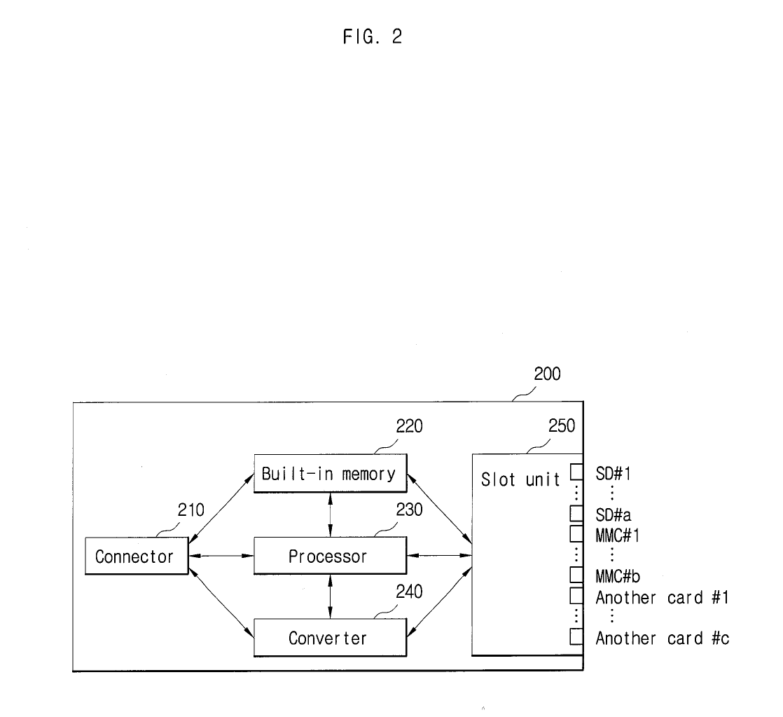

FIG. 2 shows the structure of a memory card changer in accordance with an embodiment of the present invention.

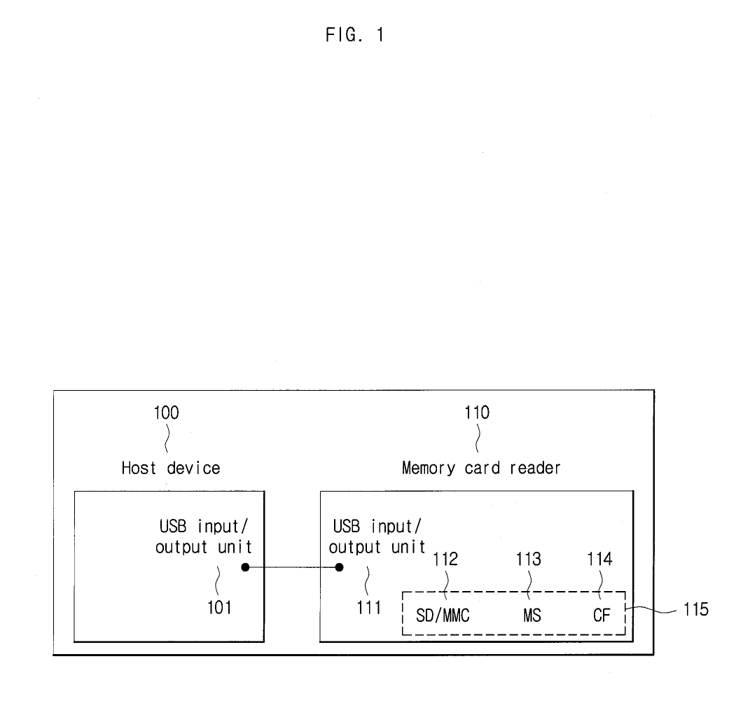

It shall be noted that throughout the description, a host device 100 used in describing a memory card changer 200 in accordance with an embodiment of the present invention refers to the host device 100 shown in FIG. 1.

Before describing the drawings in detail, it shall be noted that the distinction of elements is for distinguishing the main function of each element. That is, two or more elements can be joined as one element, or an element can be functionally divided into two or more elements. Moreover, each element described below can perform not only its main function but also part or whole of the functions of other elements. Conversely, it is also possible that a part of the main functions pertained to each element can be fully performed by other elements. Therefore, the presence of each element, described in the description, can be functionally interpreted. For that reason, it shall be obvious that a configuration of the elements, in accordance with the memory card changer 200 of the present invention, can differ from one illustrated in FIG. 2, without departing from the spirit and technical scope of the present invention.

Referring to FIG. 2, the memory card changer 200 in accordance with an embodiment of the present invention includes a connector 210, a built-in memory 220, a processor 230, a converter 240 and a slot unit 250.

The connector 210 interchanges data between a host device 100 and a memory card changer 200.

The connector 210 can have a variety of interfaces for interchanging the data in accordance with interfaces supported by the host device 100. For instance, the connector 210 can have one of the interfaces such as Universal Serial Bus (USB), Secure Digital (SD), MultiMediaCard (MMC), xD-Picture Card (xD), Trans Flash (T-Flash) and Subscriber Identity Module (SIM).

Below, it shall be assumed that the connector 210 interchanges the data between the host device 100 and the memory card changer 200 by using a USB interface. It shall be obvious, however, that the present invention is not restricted to the use of USB interface.

The built-in memory 220 can be one or more of flash memory or fusion memory. Here, the fusion memory is a device that integrates different types of memories, such as DRAM, SRAM and flash memory, and logics on a single chip to lead the digital appliances market facing new demands in a digital convergence era. In other words, the fusion memory is a next-generation semiconductor that includes the large storage capacity of DRAM, the high speed data processing of SRAM, the nonvolatile storage of flash memory and a characteristic and outstanding attribute that a logic semiconductor has. These attributes, coupled with on-chip logic circuits, allow for customization of the chip to meet desired specifications. The fusion memory is a kind of MCP (Multi Chip Package), which is a device integrating different types of memories on a single chip, such as DRAM, SRAM and flash memory, and is often used for mobile devices, such as mobile telephones, PDAs (Personal Digital Assistants) and digital cameras.

The slot unit 250 has a plurality of slots to which a plurality of external memory cards can be attached at the same time. Here, the plurality of external memory cards can include not only Compact Flash (CF), Smart Media (SM), MultiMediaCard (MMC), RS-MultiMedia Card (RS), xD-Picture Card (xD), Memory Stick (MS), Memory Stick Duo (MS Duo), Memory Stick Pro Duo (MS Pro Duo),Memory Stick PRO true 4-bit (MS PRO), MagicGate (MG), Secure Digital (SD), Mini-Secure Digital (Mini SD) and Trans Flash (T-Flash) but also Subscriber Identity Module (SIM), Universal Subscriber Identity Module (USIM), Mega Subscriber Identity Module (Mega SIM) that have memory.

The converter 240 converts the transfer method of data transferred between the connector 210 and the slot unit 250. For example, the connector 210 can interchange the data with the host device 100 through a USB interface, and the slot unit 250 can interchange the data with an external memory card through a Secure Digital (SD) interface. Here, the converter 240 can convert the data received in the connector 210 from the USB interface to the SD interface and transmit the data to the slot unit 250.

The processor 230 can control the host device 100, connected with the memory card changer 200, to recognize individual storage capacities of the built-in memory 220 and the external memory cards inserted in the slot unit 250 individually or collectively. Here, the memory card changer 200 can further include a switch (not shown) that can select one of an integrated mode or an independent mode, in which the integrated mode recognizes individual storage capacities of the built-in memory 250 and the external memory cards inserted in the slot unit 250 collectively and the independent mode recognizes the individual storage capacities individually, or receive from the host device 100 a signal of recognition mode selection selecting one of the integrated mode or independent mode. Here, the switch (not shown) can be mounted on each of the plurality of slots of the slot unit 250.

Moreover, if the external memory cards are attached and/or detached in the slot unit 250, or if a reset command is transmitted to the memory card changer 200 through a reset pin (not shown), the processor 230 controls the host device 100 to recognize individual storage capacities of the built-in memory 220 and the external memory cards inserted in the slot unit 250 again as a pre-determined recognition mode.

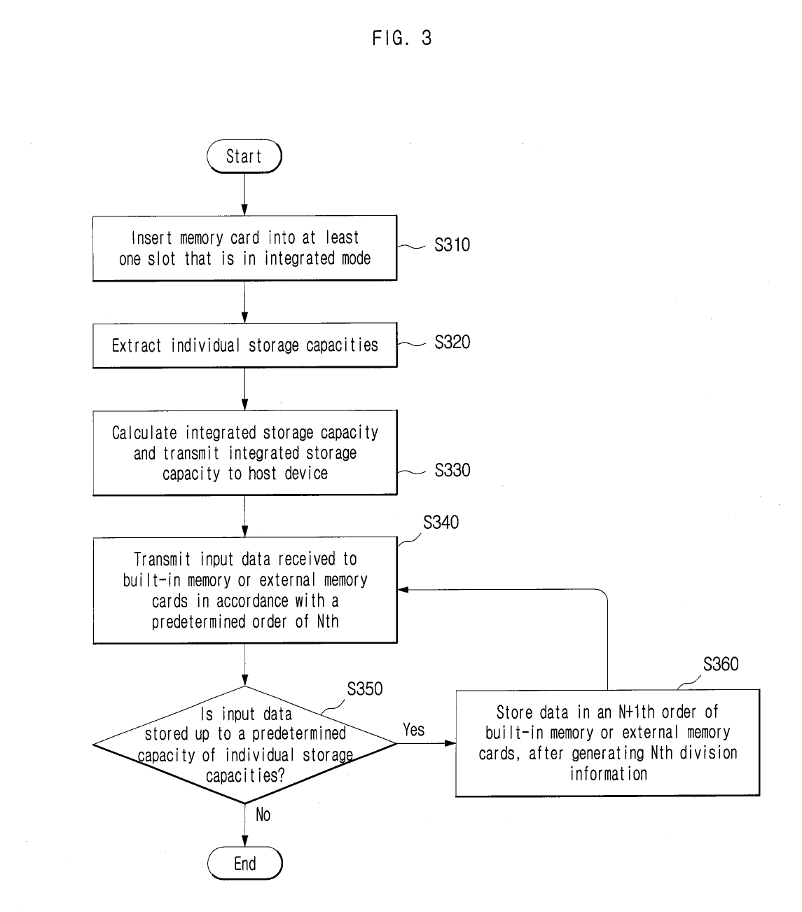

According to an embodiment of the present invention, the processor 230 can separately and successively transmit data received from the host device 100 to the built-in memory 220 and the external memory cards inserted in the slot unit 250 by a pre-determined method. This will be described later in more detail by referring to FIG. 3.

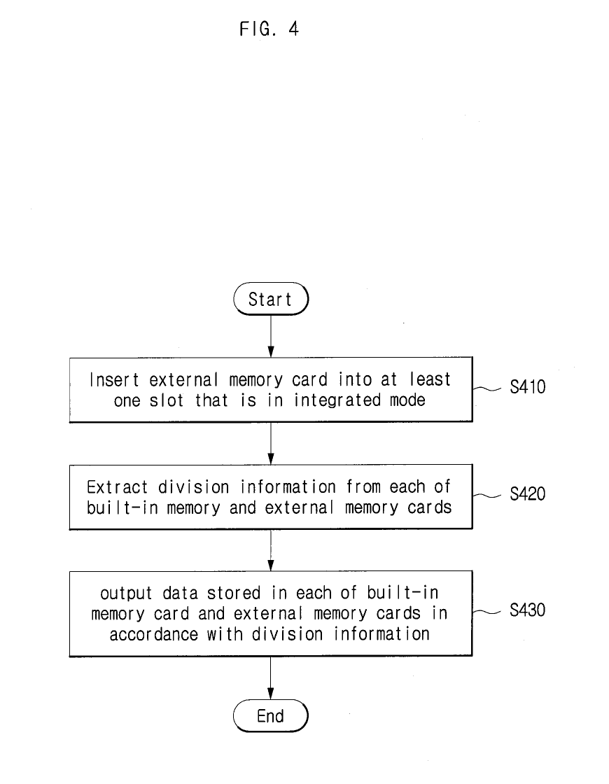

The processor 230 can also transmit the data that is separately stored in the built-in memory 220 and the external memory cards inserted in the slot unit 250 to the host device 100 through the connector 210 by a predetermined method. This will be described later in more detail by referring to FIG. 4.

Hitherto, the structure of the memory card changer 200 has been described in accordance with an embodiment of the present invention by referring to FIG. 2. Hereinafter, referring to FIG. 3, a method of storing data in a plurality of memory cards inserted in a memory card changer 200 in accordance with a first embodiment of the present invention will be described.

FIG. 3 is a flow chart illustrating how the memory card changer 200 stores data in accordance with a first embodiment of the present invention.

Referring to FIG. 3, it shall be assumed that if the memory card changer 200 receives a write command from the host device 100 in step S310, the memory card changer 200 is set to be in the integrated mode, and the plurality of external memory cards are inserted in the slot unit 250.

In step S320, the processor 230 reads information on individual storage capacities of the external memory cards inserted in the slot unit 250. In step S330, the processor 230 calculates an integrated storage capacity by adding individual storage capacities of the external memory cards and the built-in memory and transmits information on the integrated storage capacity to the host device 100. Here, the host device 100 can recognize the built-in memory and a plurality of external memory cards as a single memory card having the integrated storage capacity by using the information on the integrated storage capacity in accordance with the embodiment of the present invention.

As described with reference to FIG. 2, the switch (not shown) can be mounted on each of the plurality of slots of the slot unit 250, or the memory card changer 200 can receive from the host device 100 a recognition mode selection signal with respect to each slot. Here, by controlling the operation of the switch or the processor 230 having recognized the recognition mode selection signal from the host device 100, each slot of the slot unit 250 can be distinguished whether one is in the integrated mode or in the independent mode.

For instance, it shall be assumed that, if external memory cards are inserted in a 1^{st} slot to a 10^{th} slot, the 1^{st} slot to a 7th slot are set to be in the integrated mode, and an 8th slot to the 10th slot are set to be in the independent mode, the steps S310 and S320 shown in FIG. 3 can be applied to the built-in memory 220 and the external memory cards inserted in the 1^{st} to 7^{th} slots. In other words, the host device 100 only recognizes the built-in memory and the external memory cards inserted in the 1^{st} to 7^{th} slots as a large capacity memory card but recognizes the external memory cards inserted in the 8^{th} to 10^{th} slots as individual memory cards.

Therefore, when designating each slot of the slot unit 250 to be in one of the two modes, the step of storing data in an integrated capacity memory card that will be described below will be only applied for a specified slot that is in the integrated mode.

In accordance with the embodiment of the present invention, after the memory card changer 200 has set to the integrated mode, if the external memory card inserted in the slot unit 250 is removed, or a new external memory card is inserted in the slot, then the processor 230 can repeat the step of recognizing the integrated storage capacity described above.

For example, if 1^{st} to 3^{rd} external memory cards are inserted in 1st to 3rd slots, respectively, the host device 100 recognizes the three external memory cards as a single large capacity memory card. Then, a 4th memory card can be inserted in a 4th memory slot. In this case, the processor 230 detects that the 4th memory card has inserted in the 4th memory slot. As a result, the host device 100 recognizes the built-in memory and the 1st to 4th external memory cards as a single large capacity memory card.

In step S340, the processor 230 separately transmits data received from the host device 100 to the built-in memory 220 or the external memory cards inserted in the slot unit 250 in accordance with a predetermined method. For example, the processor 230 can designate numbers in a descending order of individual storage capacity that has been read in step S320 and stores received data in an Nth of the built-in memory 220 or the external memory card. However, the processor 230 can designate the built-in memory 220 as a first of the predetermined order, regardless of the size of the storage capacity of the built-in memory 220.

In accordance with another embodiment of the present invention, the processor 230 can read the active storage capacity of the built-in memory and the external memory cards inserted in the slot unit 250 in step S320. Here, the active storage capacity is a capacity that stores data available in the built-in memory and the external memory cards. For example, if an individual storage capacity of the built-in memory 220 is 3 gigabytes and 1 gigabyte of data is stored in the built-in memory 220, the active storage capacity of the built-in memory 220 is 2 gigabytes.

In the above case, the processor 230 can designate the order according to a descending order of active storage capacity of the built-in memory 220 and the external memory cards inserted in the slot unit 250 by using the active storage capacity read. However, the processor 230 can designate the built-in memory 220 as the first in the order regardless of the size of its storage capacity.

Hereinafter, it shall be assumed that individual storage capacities, not the active storage capacity, have been read.

In step S350, if data is stored up to a predetermined capacity of an Nth order of the built-in memory 220 or the external memory cards inserted in the slot, the processor 230 stops transmitting of the data to the Nth order of the built-in memory 220 or the external memory cards and proceeds to a next step S360.

In step S360, the processor 230 generates N division information and stores the N division information in the Nth order of the built-in memory 220 or the external memory cards. Here, the N division information is used for restoring data. For example, the N division information can contain a name of data, code information related to a time when storing of data is stopped or sequence information related to how the data is divided and in which external memory cards the divided data is stored. Here, it is evident to any person of ordinary skills in the art that the Nth division information can be modified and changed according to an environment to which the memory card changer 200 is applied.

In step S360, the processor 230 proceeds to the step S340 by adding 1 to the N. That is, the processor 230 can store data remaining after the storing of the data is stopped in an N+1th order of the built-in memory 220 or the external memory cards.

As such, the processor 230 can proceed to the steps S340 to S360 until the storing of the data is completed.

However, if the predetermined capacity of the Nth order of the built-in memory 220 or the external memory cards is not fully stored by the data in step S350, the processor 230 determines that storing the data is completed. In the case, the storing of the data is stopped, and the processor 230 can generate division information that contains information about the complete storing of the data and store the division information in the memory card 220 or the external memory cards that are corresponding to the division information, which is not illustrated in FIG. 3.

The embodiment of the present invention that has been described with reference to FIG. 3 will be described further through a specific example below.

It shall be assumed that, in step S310, the built-in memory has 1 gigabyte of individual storage capacity, and 1st and 2nd external memory cards that have individual storage capacities of 1 gigabyte and 0.5 gigabyte, respectively, are inserted in 1st and 2nd slots, respectively. Then, in step S320, the processor 230 extracts individual storage capacities of the external memory cards and, in step S330, calculates the integrated storage capacity that is a total of 2.5 gigabytes. After these steps, the processor 230 transmits information on the integrated storage capacity to the host device 100, and then the host device 100 recognizes the built-in memory and the 1st and 2nd external memory cards as a single memory card of large capacity having the integrated storage capacity of 2.5 gigabytes.

Here, the steps S340 to S360 will be described by assuming that the built-in memory 220 and each of the external memory cards are numbered regardless of the order of individual capacity of the built-in memory 220 and each of the external memory cards and data is stored up to 100% of the individual storage capacities.

If the memory card changer 200 having received 1.7 gigabytes of data from the host device 100 stores the data in the built-in memory 220 and the external memory cards, the processor 230 stores 1 gigabyte of data in a 1st built-in memory 220, generates 1st division information and then stores the 1st division information in the 1st memory card. Moreover, the processor 230 proceeds to store data remaining, i.e. 0.7 gigabytes of data, in a 1st external memory card that is the second in the order.

In the above case, the processor 230 can use the remaining storage capacity, i.e. 0.3 gigabytes, of the 1st external memory card being the second in the predetermined order and the storage capacity of the 2nd external memory card being the third in the predetermined order for another use of storing data.

Hitherto, the method of storing data performed by the memory card changer 200 has been described with reference to FIG. 3 in accordance with an embodiment of the present invention. Hereinafter, a method of reading data from the memory card changer 200 in accordance with another embodiment of the present invention will be described by referring to FIG. 4.

FIG. 4 is a flowchart illustrating how the memory card changer 200 reads data in accordance with another embodiment of the present invention. Referring to FIG. 4, it shall be assumed that, in step S410, 1^{st} to 5^{th} external memory cards are inserted in 1^{st} to 5^{th} external memory slots, respectively, and data is divided and stored in the built-in memory 220 and the 1st to 5th external memory cards. A portion of the data stored in the built-in memory 220 is called 1st division data, and portions of the data stored in the 1st to 5th external memory cards are called 2^{nd} to 6^{th} division data, respectively.

In step S420, the processor 230 first extracts the 1st to 6th division information from the built-in memory 220 and the 1st to 5th external memory cards and then sorts an order of the 1st to 6th division data by using the 1st to 6th division information. For instance, it shall be assumed that the original data is divided and stored in the order of the built-in memory 220, the 1st external memory card, the 2nd external memory card, the 5th external memory card, the 4th external memory card and the 3rd external memory card. In this case, the processor 230 recognizes that the original data is divided and stored in the built-in memory 220, the 1st external memory card, the 2nd external memory card, the 5th external memory card, the 4th external memory card and the 3rd external memory card, respectively, by using the 1st to 6th division information.

In step S420, the processor 230 can transmit the division data, stored in the built-in memory 220 and the external memory cards, to the host device 100 through the connector 210 in the order of the built-in memory 220, the 1st external memory card, the 2nd external memory card, the 5th external memory card, the 4th external memory card and the 3rd external memory card.

Here, the converter 240 can convert the method of transferring the data to the host device 100 in accordance with an interface type of the connector 210.

Hitherto, the method of reading data performed by the memory card changer 200 has been described with reference to FIG. 4 in accordance with an embodiment of the present invention.

While the spirit of the invention has been described in detail with reference to particular embodiments, the embodiments are for illustrative purposes only and shall not limit the invention. Therefore, those with ordinary skill in the art will understand that many variations and other embodiments may be made without departing from the scope of the invention as set forth in the appended claims.

1. A memory card changer configured to be connected to a host device and read data from a plurality of external memory cards or store data in the plurality of external memory cards, the memory card changer comprising:
a connector configured to interchange the data with the host device;
a built-in memory;
a slot unit configured to attach and detach the plurality of external memory cards; and
a processor configured to control the host device to collectively recognize or individually recognize individual storage capacities of the built-in memory and each of the memory cards inserted in the slot unit.

2. The memory card changer of claim 1 , further comprising a switch configured to designate one of an integrated mode and an independent mode, the integrated mode recognizing the individual storage capacities collectively, the independent mode recognizing the individual storage capacities individually,
wherein if the integrated mode is designate, the processor allows the host device to collectively recognize the individual storage capacities of the built-in memory
and the external memory cards inserted in the slot unit.

3. The memory card changer of claim 1, wherein:
a recognition mode selection signal can be received from the host device, the recognition mode selection signal having selected one of the integrated mode and the independent mode, the integrated mode recognizing the individual storage capacities collectively, the independent mode recognizing the individual storage capacities individually;
and if the integrated mode is selected by receiving the recognition mode selection signal having selected the integrated mode, the processor controls the host device to recognize the individual storage capacities of the built-in memory and the external memory cards inserted in the slot unit collectively.

4. The memory card changer of claim 1, wherein, if attachment and/or detachment of some of the external memory cards is recognized, the processor controls the host device to re-recognize the individual storage capacities of the external memory cards inserted in the slot unit.

5. The memory card changer of claim 1, further comprising a reset pin configured to generate a reset signal,
wherein, if the reset signal is generated by an operation of the reset pin, the processor controls the host device to re-recognize the individual storage capacities of the external memory cards inserted in the slot unit.

6. The memory card changer of claim 1, wherein, if the individual storage capabilities are collectively recognized and a write command is received from the host device, the processor divides data received from the host device and transmits the divided data to the built-in memory or the external memory cards inserted in the slot unit by using a predetermined method.

7. The memory card changer of claim 6, wherein the predetermined method stores the data in the built-in memory or the external memory cards inserted in the slot unit in accordance with a predetermined order,
whereas, if the data is stored up to a predetermined capacity of an Nth order of the built-in memory or the external memory cards inserted in the slot unit, Nth division information is generated and stored in the built-in memory or the external memory cards inserted in the slot unit, and then data following the data stored in the Nth order of the built-in memory or the external memory cards is stored in an N+1th order of the built-in memory or the external memory cards inserted in the slot unit.

8. The memory card changer of claim 7, wherein a first of the predetermined order is the built-in memory.

9. The memory card changer of claim 7, wherein the N is designated in a descending order of individual storage capacity or active storage capacity of the built-in memory and the external memory cards inserted in the slot unit.

10. The memory card changer of claim 1, wherein, if the individual storage capabilities are collectively recognized and a read command is received from the host device, the processor extracts division information from each of the built-in memory and the external memory cards inserted in the slot unit and transmits the data stored in the built-in memory and the external memory cards inserted in the slot unit to the connector by using the extracted division information,
whereas the division information is stored in the built-in memory and the external memory cards inserted in the slot unit when the data is divided and stored in the built-in memory and the external memory cards inserted in the slot unit and comprises information on the divided data.

11. The memory card changer according to claims 1, further comprising a converter, configured to convert a method of transferring data transferred between the connector and the slot unit in accordance with an interface type of the connector and the slot unit.

12. The memory card changer of claim 6, further comprising a converter, configured to convert a method of transferring data transferred between the connector and the slot unit in accordance with an interface type of the connector and the slot unit.

13. The memory card changer of claim 10, further comprising a converter, configured to convert a method of transferring data transferred between the connector and the slot unit in accordance with an interface type of the connector and the slot unit.

14. The memory card changer of claim 1 , wherein the external memory cards include at least one memory card selected from the group consisting of Compact Flash (CF), Smart Media (SM), MultiMedia Card (MMC), RS-MultiMedia Card (RS), xD-Picture Card (xD), Memory Stick (MS), Memory Stick Duo (MS Duo), Memory Stick Pro Duo (MS Pro Duo),Memory Stick PRO true 4-bit (MS PRO), Magic Gate (MG), Secure Digital (SD), Mini-Secure Digital (Mini SD), Trans Flash (T-Flash) and Subscriber Identity Module (SIM), Universal Subscriber Identity Module (USIM) and Mega Subscriber Identity Module (Mega SIM), each of the Subscriber Identity Module (SIM), the Universal Subscriber Identity Module (USIM) and the Mega Subscriber Identity Module (Mega SIM) having a memory.

15. The memory card changer of claim 1 , wherein the connector has at least one interface type selected from the group consisting of Universal Serial Bus (USB), Secure Digital (SD), MultiMedia Card (MMC), xD-Picture Card (xD), Trans Flash (T-Flash) and Subscriber Identity Module (SIM).

16. The memory card changer of claim 1, wherein the built-in memory is one or more of a Flash memory or a Fusion memory.

17. A method of storing data in a built-in memory of a memory card changer and an external memory card inserted in the memory card changer, the method comprising:
(a) storing the data in the built-in memory or the external memory card in accordance with a predetermined order;
(b) generating Nth division information and storing the Nth division information in the built-in memory or the external memory card, if data is stored up to a predetermined capacity of an Nth order of the built-in memory or the external memory card;
(c) storing data following the data stored in the Nth order of the built-in memory or the external memory card in an N+1th order of the built-in memory or the external memory card; and
(d) repeating the steps of (b) and (c) until the data is completely stored.

18. The method of claim 17, wherein the N is designated in a descending order of individual storage capacity or active storage capacity of the built-in memory and the external memory cards.

19. A method of reading data stored in a built-in memory of a memory card changer and an external memory card inserted in the memory card changer, the method comprising:
extracting division information from each of the built-in memory and the external memory card; and
reading the data stored in the built-in memory and the external memory card by using the extracted division information,
wherein the division information is stored in the built-in memory and the external memory card when the data is divided and stored in the built-in memory and the external memory card and comprises information on the divided data.
